(19) United States
(12) Patent Application Publication
(10) Pub. No.: US 2015/0082637 A1
(43) Pub. Date: Mar. 26, 2015

(54) ROTARY ELECTRIC SHAVER HEAD

(71) Applicant: SHANGHAI POVOS ELECTRIC WORKS CO., LTD., Shanghia (CN)

(72) Inventor: Weiming Liu, Shanghai (CN)

(73) Assignee: SHANGHAI POVOS ELECTRIC WORKS CO., LTD., Shanghai (CN)

(21) Appl. No.: 14/380,821

(22) PCT Filed: Oct. 17, 2012
(86) PCT No.: PCT/CN2012/001395

§ 371 Date: Aug. 25, 2014

(30) Foreign Application Priority Data
Oct. 18, 2011 (CN) 201110317261.2
Oct. 18, 2011 (CN) 201120397666.7

(51) Int. Cl. B26B 19/14

(52) U.S. Cl. CPC B26B 19/143; B26B 19/141
USPC 30/43.6

(57) ABSTRACT

The present invention claims a rotary type electric shaver head, wherein a cutter mesh enclosure of the rotary type electric shaver head is provided with a wavy curved surface; a C-shaped or S-shaped beard inlet slot is formed on the cutter mesh enclosure; the beard inlet slot is the combination of a circular hole and a slot, or the combination of a long slot and a short slot; a moving cutter is fixedly arranged on a driving connector in a hot-pressing and melting mode, thereby forming a moving cutter component; an upper tapered surface of a tapered-surface driving shaft is in contact with an inner tapered surface of a driving shaft sleeve, thereby driving the moving cutter component; the moving cutter component is arranged on a boss on the inner surface of an elastic cutter holder; while being rotated, the moving cutter component is only in contact with the boss (11) on the inner surface of the elastic cutter holder; an upward fastening force is applied to the moving cutter component by the elastic cutter holder, and the elastic cutter holder is connected with the cutter mesh enclosure; and under the action of the fastening force, the moving cutter component is in tight contact with the inner surface of the cutter mesh enclosure. By utilizing the rotary type electric shaver head provided by the present invention, the problems of beard clamping, beard pulling, low sharpness degree, noisy shaving and so on, of the traditional shaver head are solved, and the skin outline of human face is perfectly caught, and the more efficient, comfortable and thorough shaving feeling is achieved.

### TECHNICAL FIELD

The present invention relates to technical field of the electric shaver head, specifically to a shaver head used for the rotary type electric shaver.

### BACKGROUND ART

At present, there are mainly two types of electric shavers on the market: reciprocating type and rotary type. Generally, the comfort level, efficiency (speed) and cleanliness of shaving directly rely on the face outline and beard condition of the user as well as shaver head structure of the shaver. The reciprocating type shaver is suitable for short, hard and straight beard. Because the contact area of the reciprocating type shaver surface with the face skin is big, the cutter mesh is thin (about 0.06 mm) and rotating speed the shaver head is generally greater than 8000 RPM, it has good effect on shaving the short straight beard. However, the greatest disadvantage of the reciprocating type shaver is that the vibration thereof is very strong; besides, it is not suitable for shaving beard on local hard-to-reach part, and it is not easy for it to shave the bent or soft beard. The rotary type shaver overcomes the disadvantages of the reciprocating type shaver. Because the transmission mechanism adopts a reduction gear mechanism, the rotating speed of the shaver head is generally about 3000 RPM; as a result, vibration while shaving is not strong, the quiet shaving experience is achieved, and the bent beard at local hard-to-reach part can also be shaved; however, the overall shaving efficiency is low, the fitness between the shaver head and the face skin is not good, and the cutter mesh is thick (0.06-0.12 mm, local thickness of the cutter mesh can be up to 0.12 mm), which causes problems that root part of the beard cannot be shaved, the shaving is not thoroughly completed and the comfort level of shaving is low.

In order to overcome the above disadvantages of the rotary type shaver, the domestic and abroad shaver manufacturers like the Holland Philips Corporation developed the arc-shaped shaver head so as to replace the flat shaver head (as shown in FIG. 2), thereby increasing the fit of the shaver head and face skin. In order to effectively increase the shaving area and improve shaving efficiency and comfort level, the domestic and abroad shaver manufacturers all strengthened the research and development on the shaver head in recent years, and developed dual-circle and triple-circle arc-shaped shaver head structures, and some manufacturers even developed design concept of four-circle arc-shaped shaver head. On the shaver head mesh with an outer diameter of only φ 20.4 mm, the increase of circles will definitely increase difficulty of manufacturing the shaver head. Take manufacture of the traditional triple-circle arc-shaped shaver head for example, it is mandatory to thin and polish the shaver head mesh (cutter mesh enclosure 7) for three times; besides, in order to guarantee fit of the cutter mesh enclosure 7 and the moving cutter 8, it is necessary to polish the three inner surface of the cutter mesh enclosure 7; moreover, the increase of circles cannot realize all arc-shaped surface shaving; the moving cutter 8 and the cutter mesh enclosure 7 must avoid the connection part among the circles, so there must be gaps among the circles which cannot be used to shave. In addition, the complex technique and equipment to process the arc-shaped shaver head require very high level technician. Although some domestic manufacturers have manufactured the arc-shaped shaver head, massive production cannot be realized because of the high production cost; besides, the quality is not stable so it cannot go on sale. Therefore, it is significant to develop a rotary type shaver head that is big in working surface, high in shaving efficiency and easy to manufacture, and can provide comfortable shaving experience.

### SUMMARY OF THE INVENTION

The technical problem to be solved in the present invention is to provide a rotary type electric shaver head that has advantages of high shaving speed, good shaving tune quality, good fitness effect and high comfort level, as well as easy production.

In order to solve the above technical problem, the present invention provides the technical proposal as follows: A rotary type electric shaver head which comprises a cutter mesh enclosure having a wavy curved surface, a driving shaft sleeve, a tapered-surface driving shaft, a moving cutter, an elastic cutter holder and a driving connector, wherein:

A C-shaped or S-shaped beard inlet slot is formed on the cutter mesh enclosure; the beard inlet slot is the combination of a circular hole and a slot, or the combination of a long slot and a short slot;

A moving cutter is fixedly arranged on a driving connector in a hot-pressing and melting mode, thereby forming a moving cutter component; an upper tapered surface of a tapered-surface driving shaft is in contact with an inner tapered surface of a driving shaft sleeve, thereby driving the moving cutter component; the moving cutter component is arranged on a boss on the inner surface of an elastic cutter holder; while being rotated, the moving cutter component is only in contact with the boss (11) on the inner surface of the elastic cutter holder;

An upward fastening force is applied to the moving cutter component by the elastic cutter holder, and the elastic cutter holder is connected with the cutter mesh enclosure; and under the action of the fastening force, the moving cutter component is in tight contact with the inner surface of the cutter mesh enclosure.

Compared to the prior art, the moving cutter component of the present invention, under the action of the fastening force from the elastic cutter holder, can be in close contact with the inner surface of the cutter mesh enclosure, thereby improving the sharpness of the cutter; under the action of the fastening force, the upper tapered surface of a tapered-surface driving shaft can be in accurate fit with the inner tapered surface of the driving shaft sleeve on the cutter mesh enclosure, thereby ensuring that the moving component can rotate along the axial center direction without problem of offset, so as to realize smooth shaving without problems of bearing clamping or beard pulling.

In addition, because of the wavy mesh surface structure of the present invention, the cutter mesh is thinner, and the inner shaver head is completely in contact with the cutter mesh enclosure, thereby realizing shaving on overall mesh surface and maximum shaving area; radian of the mesh surface fits with the skin outline of human face better; due to the innovative design of an independent rotary tapered-surface transmission mechanism and an elastic strengthening structure, the moving cutter is correctly located and in close contact with the cutter mesh enclosure; therefore, faster shaving, better shaving sharpness, better shaving tune quality and shaving feeling are realized. In addition, the present invention is relatively simple in manufacturing process, low in material cost, suitable for massive production, and it can bring high economic benefit.

### BRIEF DESCRIPTION OF THE DRAWINGS

FIG. 1 is the inner structure diagram of the shaver head of the present invention.

FIG. 2 is the inner structure diagram of the existing shaver head on the market.

FIG. 3 is the exploded view of the shaver head of the present invention.

FIG. 4 is the schematic diagram of the wavy cutter mesh enclosure 1 of the present invention.

FIG. 5 is the external schematic diagram of the cutter mesh enclosure 1 that is the combination of long and short slots.

FIG. 6 is the external schematic diagram of the cutter mesh enclosure 1 that is the combination of holes and slots.

FIG. 7 is the section view of the cutter mesh enclosure 1 of the present invention.

FIG. 8 is the section view of the cutter mesh enclosure on the market.

FIG. 9 is the embedding structure diagram of the elastic cutter holder 5 of the shaver head of the present invention.

Wherein: 1. Cutter mesh enclosure; 2. Driving shaft sleeve; 3. Tapered-surface driving shaft; 4. Moving cutter; 5. Elastic cutter holder; 6. Driving connector; 7. Cutter mesh enclosure of the shaver head on the market; 8. Moving cutter of the shaver head on the market; 9. Locating column of the shaver head on the market; 10. Supporting column; 11. Boss; 12. Upper taper surface; 13. Inner tapered surface.

### DETAILED DESCRIPTION OF THE PREFERRED EMBODIMENTS

The following is the further explanation of the present invention in combination with the drawings and detailed embodiments. These embodiments shall be regarded as explanation of the present invention but not limiting the protection scope. After reading the content recorded in the present invention, the technician of this field can change or modify the present invention; all the equivalent changes and modifications shall fall into the scope defined by the claims of the present invention.

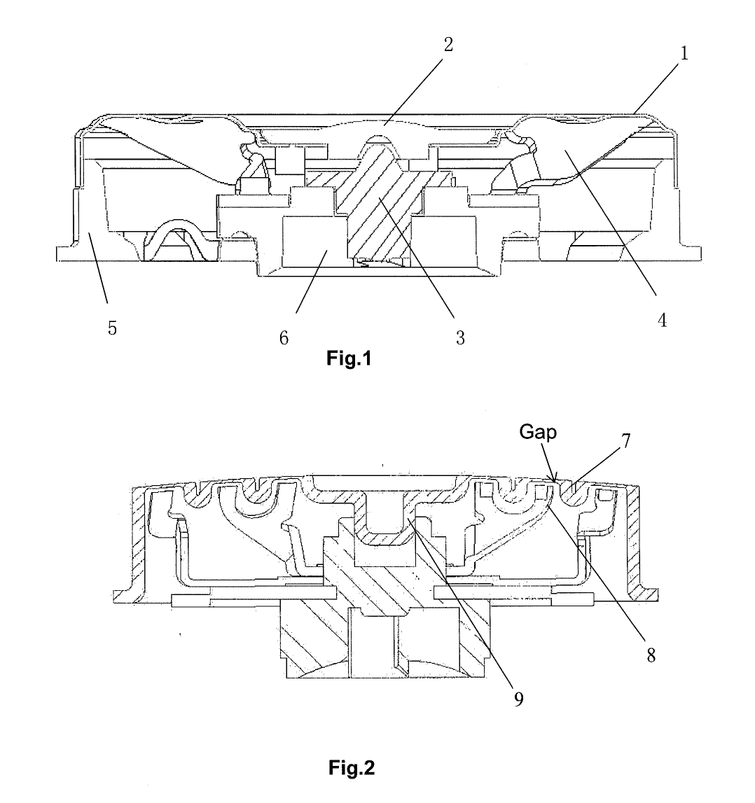

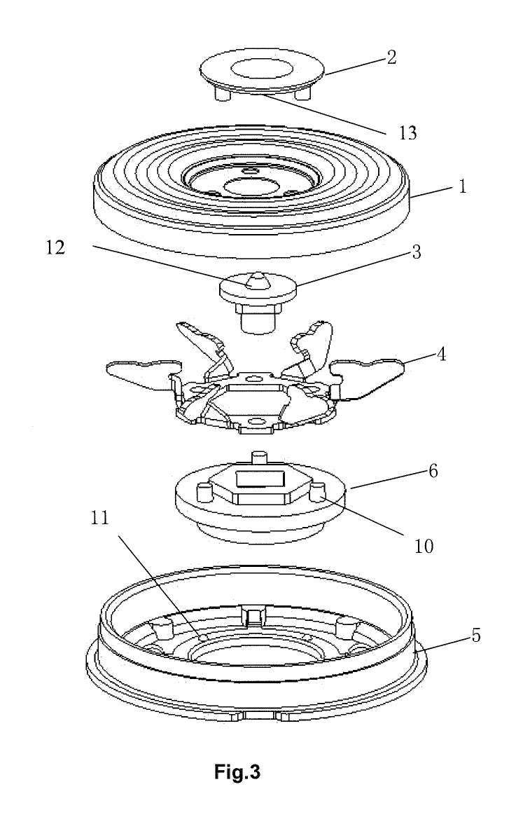

As shown in FIG. 1 and FIG. 3, the preferred embodiment of the present invention claims a rotary type electric shaver head which comprises a cutter mesh enclosure 1 having a wavy curved surface, a driving shaft sleeve 2, a tapered-surface driving shaft 3, a moving cutter 4, an elastic cutter holder 5 and a driving connector 6; wherein:

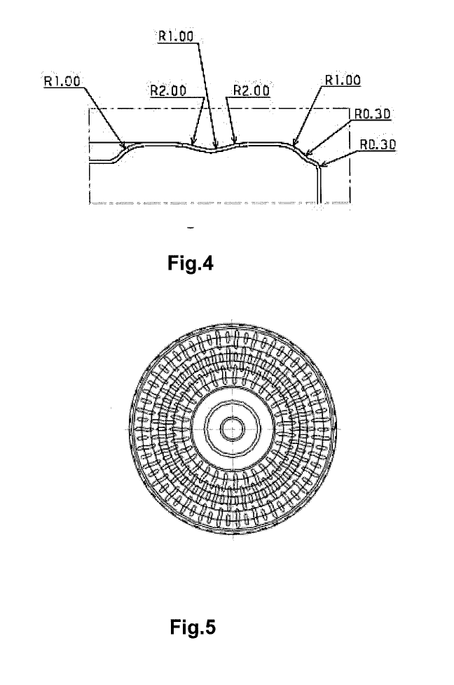

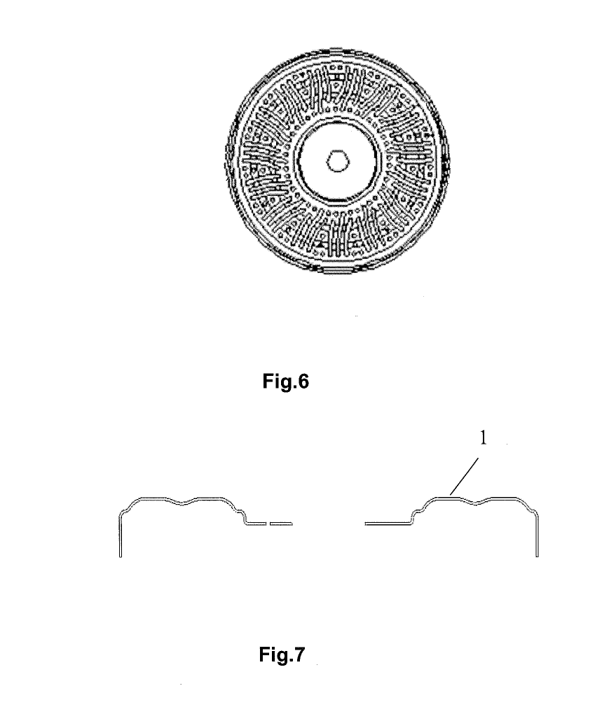

The cutter mesh enclosure 1 has 2-4 sections of wavy curved surfaces (as shown in FIG. 4 and FIG. 7), thickness of the cutter mesh enclosure is 0.05-0.12 mm, preferably 0.08-0.1 mm, and the material is stainless steel or plastics, preferably stainless steel. The stainless steel material is stretched to form a wavy shape by punching; he wavy structure is of a certain rigidity and capable of preventing from deformation; a proper height difference (0.2 mm-0.5 mm) is formed between the peak and valley, so as to effectively catch long and short beard of human; both peak and valley have the shaving function. In addition, C-shaped or S-shaped beard inlet slots or holes (as shown in the FIG. 5 and FIG. 6) are formed on the cutter mesh enclosure 1.

In the embodiment, the rotary shaft is formed by a driving shaft sleeve 2 and a tapered-surface driving shaft 3, and the moving cutter 4 is mounted on three supporting columns 10 of the driving connector 6 to fixedly form a moving cutter component in a hot-pressing and melting mode; a square hole is formed in the center of the driving connector 6, and the tapered-surface driving shaft 3 is inserted into the hoe; a motor transfers the power to the lower end of the driving connector 6 through a reduction gear and a driving arm, thus to drive the connector 6 to rotate and drive the tapered-surface driving shaft 3 to rotate. Because there is no locating column 9 (as shown in FIG. 2) stretched by punching on the cutter mesh enclosure 1 of the embodiment, this punching manufacturing procedure can save 7-8 steps compared to the shaver head punching procedure in prior art, without problems of beard clamping and beard pulling due to worse rotary locating of the moving cutter and deviation from axis caused by deformation of the locating column 9. The moving cutter component is in tight contact with the inner taper surface 13 of the driving shaft sleeve 2 that is fixedly arranged on the cutter mesh enclosure 1 through the upper tapered surface 12 on the tapered-surface driving shaft 3; and the moving cutter component is arranged on the four bosses 11 on the inner surface of the elastic cutter holder 5; while rotating, the moving cutter component is only in contact with the bosses 11 on the inner surface of the elastic cutter holder 5, but not in contact with the whole inner circular surface of the elastic cutter holder, so as to reduce the friction force of the elastic cutter holder while rotating, reduce the load current and improve the durability of battery. The elastic cutter holder 5 applies an upward fastening force to the moving cutter component and the tapered-surface driving shaft 3, and is fixedly connected with the cutter mesh enclosure 1. There are a plurality of methods of connecting the elastic cutter holder 5 and the cutter mesh enclosure 1; if the elastic cutter holder 5 is made of metal, the connecting method can be spot welding; if the elastic cutter holder 5 is made of plastics (Polyoxymethylene (POM) or Acrylonitrile Butadiene Styrene (ABS)), an embedding and blocking manner (as shown in FIG. 9) can be applied to joint part of the elastic cutter holder and the cutter mesh enclosure. Under the action of the fastening force, the moving cutter component 5 is in tight contact with the inner surface of the cutter mesh enclosure 1, thereby improving the sharpness for shaving, and the upper tapered surface 12 on the tapered-surface driving shaft 3 can also be in accurate fit with the inner taper surface 13 of the driving shaft sleeve 2 on the cutter mesh enclosure 1, so as to ensure that the moving cutter component can rotate along the axis direction without problem of deviation, and realize more smooth shaving and prevent from beard clamping or beard pulling problems.

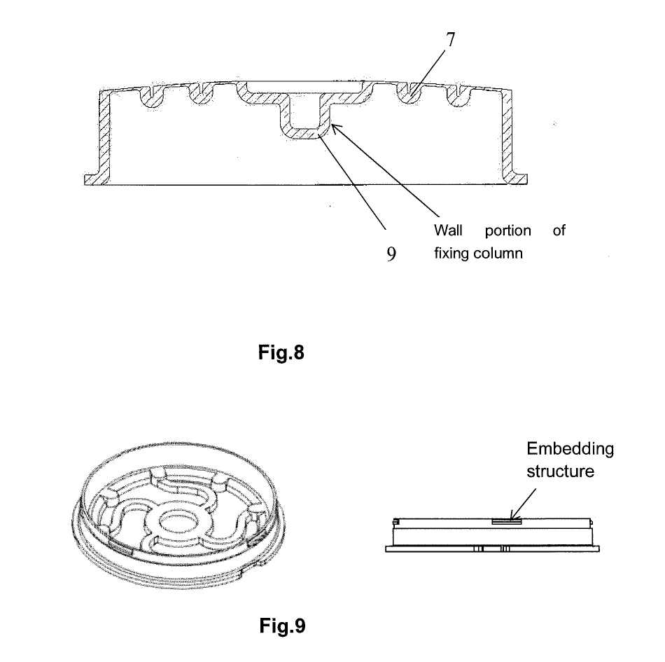

In the embodiment, the beard inlet slot can be formed on the cutter mesh enclosure (1) while punching, or can be formed by electrolysis after punching, preferably by punching. Because thickness of the material is only 0.08-0.1 mm, the locating column of the moving cutter cannot be formed by punching (the locating column 9 as shown in FIG. 8); the rotary shaft is the fixing platform and locating hole (as shown in FIG. 3) which are stretched from the central part of the cutter mesh enclosure 1 to drive the shaft sleeve 2, such that the shaft sleeve 2 and the tapered-surface driving shaft 3 form the rotating mechanism to drive the moving cutter 4 to cut relative to the cutter mesh enclosure 1. Because wall of the whole material is thin, better shaving tune quality can be generated during shaving.

As stated above, peaks and valleys of the cutter mesh enclosure 1 form a proper height difference (0.2-0.5 mm), so that long and short beard of human can be effectively caught, and both peaks and valleys can have shaving function. At present, the dual-circle and triple-circle arc-shaped shaver head structures have the problem that the transition segments among the cambered surfaces cannot be used to shave (as shown in FIG. 2); the wavy cutter mesh enclosure 1 can realize shaving function on the whole mesh enclosure, the shaving area is bigger, and the structure has the following advantages: short, straight or hard beard can be easily shaved by the peak segment of cutter mesh enclosure, and the long, soft, bent beard or beard close to the skin can be easily shaved by the valley segment of the cutter mesh enclosure; each section of peak and valley forms proper height difference, which is suitable for the beard of different length to get in; even the beard that is hard to be shaved can be shaved in different segments without any beard left. Therefore, the wavy cutter mesh enclosure structure is suitable for the complex face outline, and realizes closer and more comfortable shaving experience.

The following is the preferred embodiments to introduce the shaver head of the present invention:

### The First Embodiment

The manufacturing procedure of the shaver head of the first embodiment: punching the cutter mesh enclosure->electrolysis slotting, opening pore->injection molding->punching the moving cutter->bright heat treatment->fixing the moving cutter by hot-pressing and melting->grinding to form cutting edge for the moving cutter->matched grinding of the cutter mesh enclosure and moving cutter->polishing the cutter mesh enclosure->assembling->coating film.

Explanation to the above procedures:

Step one, the stainless steel material (SUS420J2) with a thickness of 0.1 mm is punched and stretched to form a wavy cutter mesh enclosure 1; because the material is thinner (thickness is 0.5 mm) than previous shaver head material, and different from the previous shaver head, it is unnecessary to form the locating column 9 for the blind hole at the central part, this design can greatly simplify the metal mold of the cutter mesh enclosure 1 and reduce the number of stretching times (the number of stretching times traditional blind hole can be 7-8 times or more), and it simplifies the punching steps and improves the processing accuracy of the cutter mesh enclosure (profile tolerance of cambered surface and locating size). The stainless steel surface of the cutter mesh enclosure 1 is subjected to mirror polishing treatment. The better the surface glossiness of the material is, the more subsequent processing time and steps can be saved, thereby improving the production efficiency.

Step two, by using the principle that the anode is electrolyzed by the electrochemical action of the vibrating electrode in the manner of electrolysis, the slot or hole of the cutter mesh enclosure is processed to form the beard inlet slot or hole, and distribution of the slot and hole can be adjusted according to actual requirement. The slot width is 0.35-0.45 mm, and the diameter of hole is 0.3-0.45 mm; or according to actual requirement, combination of slot and hole (as shown in FIG. 6) or combination of long slot and short slot (as shown in FIG. 5) can be used. Because of the wavy cambered surface of the cutter mesh enclosure, the slot formed by electrolysis can be C-shaped or S-shaped, so as to guarantee that the beard can be easily introduced into the enclosure, prevent the beard from loosing while shaving, and keep the shaved beard inside of the enclosure.

Step three, the driving shaft sleeve 2, the tapered-surface driving shaft 3, the elastic cutter holder 5 and the driving connector 6 are molded through injection molding by the injection molding machine; the plastic material is the POM material or ABS material having strong abrasive resistance, certain hardness and toughness; in order to improve the strength and prolong the service life, the POM material can be modified POM (for example, POM+20% glass fiber).

Step four, the stainless steel material (SUS420J2) of 0.4 mm thick is used to form the moving cutter 4 by punching, in order to reduce the load current and improve sharpness of shaving, the angle of inclination of the cutting edge of the moving cutter is 40-60 degrees, and the contact area of the cutting edge and the cutter mesh enclosure should be as smaller as possible.

Step five, the moving cutter 4 and the cutter mesh enclosure 1 are subjected to bright heat treatment. The quenching temperature is controlled to be 950-1020 degrees centigrade, and low temperature tempering at 250-350 degrees centigrade is carried out to guarantee the internal stress of the material is released. The heat treatment process enables the cutter mesh enclosure 1 and the moving cutter 4 to have proper hardness (530-600 HV), toughness and abrasive resistance, thus to prolong the service life of the shaver head. During the electrolysis in step two to process the slot and hole for the cutter mesh enclosure, the hardness of the material does not influence the processing efficiency too much, in order to avoid deformation of the cutter mesh enclosure on which the slot and hole is processed after the heat treatment, the slot and hole can be processed by electrolysis after the heat treatment.

Step six, the moving cutter is fixed to the driving connector 6 in the hot-pressing and melting manner, and the cutting edge of the moving cutter component is formed by grinding. Because the blade is single, the grinding can be finished in one step.

Step seven, the matched grinding of the moving cutter component and the cutter mesh enclosure is carried out, so as to improve the matching degree of the cambered surface.

Step eight, the cutter mesh enclosure is subjected to polishing treatment to improve the glossiness of the external surface of the cutter mesh enclosure, and improve the shaving experience.

Step nine, the components are assembled together, and lubricating oil is applied to the contact surface of the tapered-surface driving shaft 3 and the driving shaft sleeve 2. Because the cutter mesh enclosure 1 and the elastic cutter holder 5 are fixed by embedding, it is unnecessary to welding them together.

In addition, for better shaving effect, the peak part of the cutter mesh enclosure 1 is thinned, so that the thickness of the peak part is reduced to 0.5-0.8 mm.

In order to prolong the service life and improve surface hardness of the shaver head, the cutter mesh enclosure and the moving cutter can be subjected to vacuum coating treatment; for example, ALTIN, CrCN, TI-plating treatment.

### The Second Preferred Embodiment

The manufacturing procedure of the shaver head of the second embodiment: punching the cutter mesh enclosure and the moving cutter->bright heat treatment->injection molding->grinding to form cutting edge for the moving cutter->matched grinding of the cutter mesh enclosure and moving cutter->polishing the cutter mesh enclosure->fixing the moving cutter by hot-pressing and melting->assembling.

Explanation to the above procedures:

Step one, the stainless steel material (SUS420J2) with a thickness of 0.08 mm is punched and stretched to form a wavy cutter mesh enclosure 1; during the punching process, the slot and hole are also formed. At the same time, the stainless steel material (SUS420J2) with a thickness of 0.4 mm is punched to form the moving cutter 4, and the angle of inclination of the cutting edge of the moving cutter is 40-60 degrees.

Step two, the moving cutter 4 and the cutter mesh enclosure 1 are separately subjected to bright heat treatment. The quenching temperature is controlled to be 950-1020 degrees centigrade, and low temperature tempering at 250-350 degrees centigrade is carried out. After the heat treatment, the hardness of the cutter mesh enclosure 1 and the moving cutter 4 is 530-600 HV.

Step three, the driving shaft sleeve 2, the tapered-surface driving shaft 3, the elastic cutter holder 5 and the driving connector 6 are molded through injection molding, and the plastic material is the POM material or ABS material.

Step four, the moving cutter 4 is grinded to form the cutting edge.

Step five, the matched grinding of the moving cutter 4 component and the cutter mesh enclosure 1 is carried out, so as to improve the matching degree of the cambered surface.

Step six, the cutter mesh enclosure 1 is subjected to polishing treatment to improve the glossiness of the external surface of the cutter mesh enclosure, and improve the shaving experience.

Step seven, the moving cutter 4 is fixed to the driving connector 6 in the hot-pressing and melting manner, and all components are assembled together.

Because the shaver head made in the above embodiments has the wavy mesh structure, the cutter mesh enclosure is thinner, and the inner shaver head is completely contacted with the cutter mesh enclosure, such that shaving on all the mesh enclosure is realized, the shaving area is maximized, the fitness degree of the radian of the mesh enclosure and the face outline is better; besides, by utilizing the tapered-surface driving mechanism and elasticity enhancement mechanism, the problems of beard clamping, beard pulling, low sharpness degree, noisy shaving and so on, of the traditional shaver head are solved, and the skin outline of human face is perfectly caught, and the more efficient, comfortable and thorough shaving feeling is achieved. In addition, the shaver head of the present invention is simple in manufacturing technique, low in material cost and suitable for massive production, and it can bring high economic benefit.

1. A rotary type electric shaver head, comprising a cutter mesh enclosure (1) having a wavy curved surface, a driving shaft sleeve (2), a tapered-surface driving shaft (3), a moving cutter (4), an elastic cutter holder (5) and a driving connector (6), wherein:
A C-shaped or S-shaped beard inlet slot is formed on the cutter mesh enclosure (1);
the beard inlet slot is the combination of a circular hole and a slot, or the combination of a long slot and a short slot;
A moving cutter (4) is fixedly arranged on a driving connector (6) in a hot-pressing and melting mode, thereby forming a moving cutter component; an upper tapered surface (12) of a tapered-surface driving shaft (3) is in contact with an inner tapered surface (13) of a driving shaft sleeve (2), thereby driving the moving cutter component; the moving cutter component is arranged on a boss (11) on the inner surface of an elastic cutter holder (5); while being rotated, the moving cutter component is only in contact with the boss (11) on the inner surface of the elastic cutter holder (5);
An upward fastening force is applied to the moving cutter component by the elastic cutter holder (5), and the elastic cutter holder is connected with the cutter mesh enclosure (1); and under the action of the fastening force, the moving cutter component is in tight contact with the inner surface of the cutter mesh enclosure (1).

2. The rotary type electric shaver head according to claim 1, wherein the cutter mesh enclosure (1) is made of metal material, with a thickness of 0.05-0.12 mm.

3. The rotary type electric shaver head according to claim 1, wherein the cutter mesh enclosure (1) is made of plastic material, with a thickness of 0.08-0.1 mm.

4. The rotary type electric shaver head according to claim 1, wherein the moving cutter (4) has an arc-shaped cutter, and blade of the cutter has an angle of inclination of 40-60 degrees.

5. The rotary type electric shaver head according to claim 1, wherein the elastic cutter holder (5) has a telescopic structure that can apply upward fastening force and is made of metal.

6. The rotary type electric shaver head according to claim 1, wherein the elastic cutter holder (5) has a telescopic structure that can apply upward fastening force and is made of plastics.

7. The rotary type electric shaver head according to claim 1, wherein four bosses (11) are provided on the inner surface of the elastic cutter holder (5).

8. The rotary type electric shaver head according to claim 5, wherein the elastic cutter holder (5) is connected with the cutter mesh enclosure (1) by spot welding.

9. The rotary type electric shaver head according to claim 6, wherein the elastic cutter holder (5) is connected with the cutter mesh enclosure (1) by means of embedding and blocking at the joint part.
